(19) United States
(12) Patent Application Publication
(10) Pub. No.: US 2026/0356021 A1
(43) Pub. Date: Nov. 12, 2026

(54) INJECTION MOLDING TERMINAL PULLING MACHINE

(71) Applicant: CHENG UEI PRECISION INDUSTRY CO., LTD., New Taipei City (TW)

(72) Inventors: ZHAO-YANG GUO, Dong-Guan City (CN); MING XIE, Dong-Guan City (CN); CHUNG-TING LIN, New Taipei City (TW)

(73) Assignee: CHENG UEI PRECISION INDUSTRY CO., LTD., New Taipei City (TW)

(21) Appl. No.: 19/392,651

(22) Filed: Nov. 18, 2025

(30) Foreign Application Priority Data
May 9, 2025 (CN) 202520915940.7

(51) Int. Cl. B29C 45/66; B29C 45/80

(52) U.S. Cl. CPC B29C 45/66; B29C 45/80; B29C 2945/76464

(57) ABSTRACT

An injection molding terminal pulling machine includes a base, a mold, a plurality of cameras, a cavity blocking mechanism, a feeding end arranged at one side of the mold, and a discharging end arranged at the other side of the mold. The base has a bottom board, a top board, a plurality of positioning columns, a plurality of protrusions and a plurality of supporting brackets. Upper ends and lower ends of the plurality of the positioning columns are connected to the top board and the bottom board, respectively. The mold is arranged among the bottom board, the top board and the plurality of the positioning columns. The mold has an upper mold and a lower mold. The plurality of the cameras are fixed at bottom ends of the plurality of the supporting brackets. The cavity blocking mechanism is arranged at a front end of the upper mold.

### CROSS REFERENCE TO RELATED APPLICATIONS

The present application is based on, and claims priority from, China Patent Application No. 202520915940.7, filed May 9, 2025, the disclosure of which is hereby incorporated by reference herein in its entirety.

### BACKGROUND OF THE INVENTION

### Field of the Invention

The present invention generally relates to an injection molding terminal pulling machine, and more particularly to an injection molding terminal pulling machine which automatically performs a mold closing production needless of a personnel confirmation to improve a production efficiency.

### Description of Related Art

Generally, existing material pulling operations of a mold require a lot of manpowers and time to maintain a production, so labor costs and delivery cycles remain stubbornly high. At first, operators need to manually pull a material strip to utilize a processing device to process the material strip, so that various processing parts are formed at the material strip. Then, after the processing parts of the material strip move to a cutting device, the material pulling device replaces the operator to pull the material strip.

An injection molding terminal pulling device includes a feeding end, a discharging end and an injection mold. The feeding end and the discharging end are mounted to two opposite sides of the injection mold, respectively. The feeding end includes a feeding channel which is provided for the material strip to pass through. The discharging end includes a discharging channel which is provided for the material strip to pass through. The discharging end further includes a screw assembly. The screw assembly includes a lower clamping block installed to the screw assembly. A clamping cylinder is equipped with an upper clamping block. The upper clamping block and the lower clamping block work together to clamp the material strip.

However, the injection molding terminal pulling machine is bulky, so the injection molding terminal pulling machine is inconvenient to be installed and debugged. Moreover, it is cumbersome for manually threading a material, a production efficiency is lower, and a position is just confirmed through a fiber signal to cause an insufficient accuracy.

Therefore, it is necessary to provide an injection molding terminal pulling machine which automatically performs a mold closing production needless of a personnel confirmation to improve a production efficiency.

### BRIEF SUMMARY OF THE INVENTION

An object of the present invention is to provide an injection molding terminal pulling machine which automatically performs a mold closing production needless of a personnel confirmation to improve a production efficiency. The injection molding terminal pulling machine includes a base, a mold, a plurality of cameras, a cavity blocking mechanism, a feeding end and a discharging end. The base has a bottom board, a top board, a plurality of positioning columns, a plurality of protrusions and a plurality of supporting brackets. Upper ends and lower ends of the plurality of the positioning columns are connected to the top board and the bottom board, respectively. A left side and a right side of the top board extend outward to form the plurality of the protrusions. Outer surfaces of the plurality of the protrusions protrude outward, extend vertically and then extend outward to form the plurality of the supporting brackets. The mold is arranged among the bottom board, the top board and the plurality of the positioning columns. The mold has an upper mold and a lower mold. The lower mold is positioned below the upper mold. The plurality of the cameras are fixed at bottom ends of the plurality of the supporting brackets. The plurality of the cameras are corresponding to an upper surface of the lower mold. The cavity blocking mechanism is arranged at a front end of the upper mold, and the cavity blocking mechanism is connected to the upper mold. The feeding end is arranged at one side of the mold. The feeding end is equipped with an optical fiber detection mechanism and a damper. The optical fiber detection mechanism is located to a top of the feeding end, and the damper is placed at a front end of the feeding end. The discharging end is arranged at the other side of the mold. The discharging end is equipped with a motor.

Another object of the present invention is to provide an injection molding terminal pulling machine. The injection molding terminal pulling machine is used to drive a terminal material strip. The injection molding terminal pulling machine includes a base, a mold, a feeding end, a discharging end, a plurality of cameras, a cavity blocking mechanism, an optical fiber detection mechanism, a damper, a motor and a controller. The mold is installed inside the base. The mold has an upper mold and a lower mold. The lower mold carries the terminal material strip. The upper mold has a plurality of cavities formed in the upper mold. The feeding end is arranged at one side of the mold. The discharging end is arranged at the other side of the mold. The plurality of the cameras are fixed to the base. The plurality of the cameras capture images of the terminal material strip on the lower mold to generate a monitoring signal. The cavity blocking mechanism is connected to the upper mold. The cavity blocking mechanism has a cylinder, and a plurality of sliders arranged at a rear end of the cylinder. The plurality of the sliders are aligned with the plurality of the cavities, and the plurality of the sliders are inserted into the plurality of the cavities. The optical fiber detection mechanism is located to a top of the feeding end. The optical fiber detection mechanism detects the terminal material strip to generate a position signal. The damper is placed at a front end of the feeding end. The motor is arranged at a front of the discharging end. The controller compares the monitoring signal with the position signal to control the cavity blocking mechanism.

Another object of the present invention is to provide an injection molding terminal pulling machine. The injection molding terminal pulling machine is used to drive a terminal material strip. The injection molding terminal pulling machine includes a base, a mold, a feeding end, a discharging end, a cavity blocking mechanism, an optical fiber detection mechanism, a damper, a motor and a controller. The mold is installed inside the base. The mold has an upper mold and a lower mold. The lower mold carries the terminal material strip. The upper mold has a plurality of cavities formed in the upper mold. The feeding end is arranged at one side of the mold. The discharging end is arranged at the other side of the mold. The plurality of the cameras are fixed to the base. The plurality of the cameras capture images of the terminal material strip on the lower mold to generate a monitoring signal. The cavity blocking mechanism is connected to the upper mold. Corresponding areas of the cavity blocking mechanism are aligned with the plurality of the cavities. The optical fiber detection mechanism is located to a top of the feeding end. The optical fiber detection mechanism detects the terminal material strip to generate a position signal. The damper is placed at a front end of the feeding end. The motor is arranged at a front of the discharging end. The controller compares the monitoring signal with the position signal to control the cavity blocking mechanism.

As described above, the injection molding terminal pulling machine judges whether the terminal material strip has a shortage by the optical fiber detection mechanism, and a judgment result is stored as the position signal. After the terminal material strip enters the mold, the plurality of the cameras capture the images and then output the monitoring signal. Furthermore, the controller of the injection molding terminal pulling machine compares the monitoring signal with the position signal to control an operation of the cavity blocking mechanism and an operation of the injection molding terminal pulling machine. As a result, the injection molding terminal pulling machine automatically performs a mold closing production needless of a personnel confirmation to improve a production efficiency.

### BRIEF DESCRIPTION OF THE DRAWINGS

The present invention will be apparent to those skilled in the art by reading the following description, with reference to the attached drawings, in which:

FIG. 1 is a perspective view of an injection molding terminal pulling machine according to the present invention;

FIG. 2 is a partial perspective view of the injection molding terminal pulling machine according to the present invention;

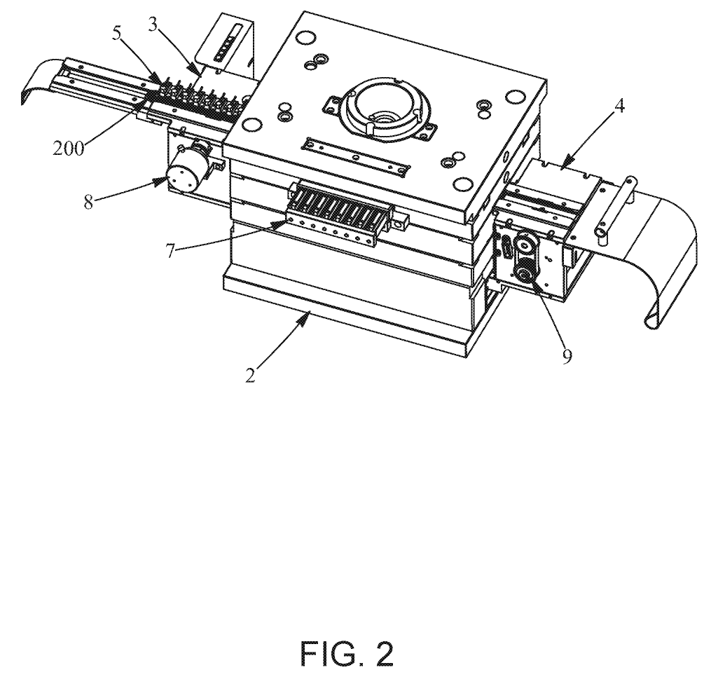

FIG. 3 is a partial exploded view of the injection molding terminal pulling machine according to the present invention;

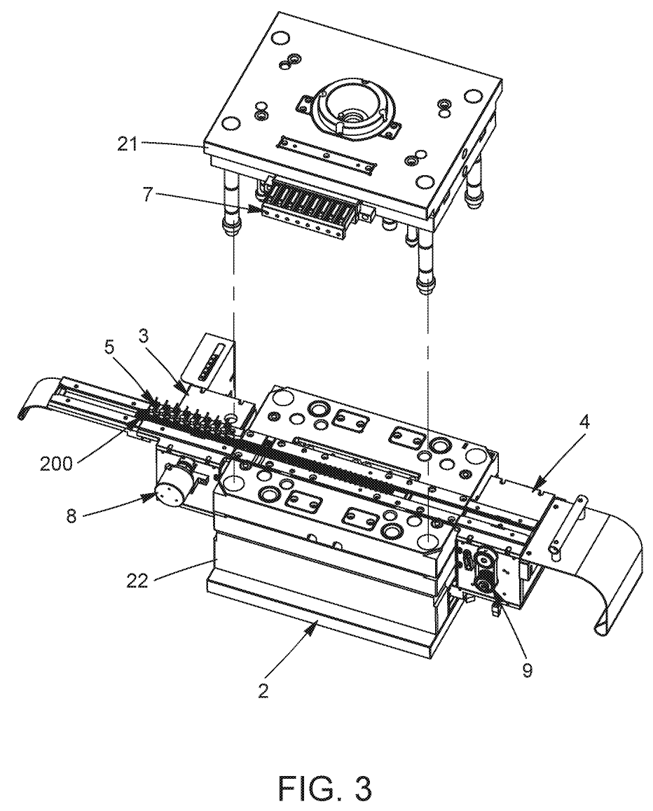

FIG. 4 is another partial exploded view of the injection molding terminal pulling machine according to the present invention; and

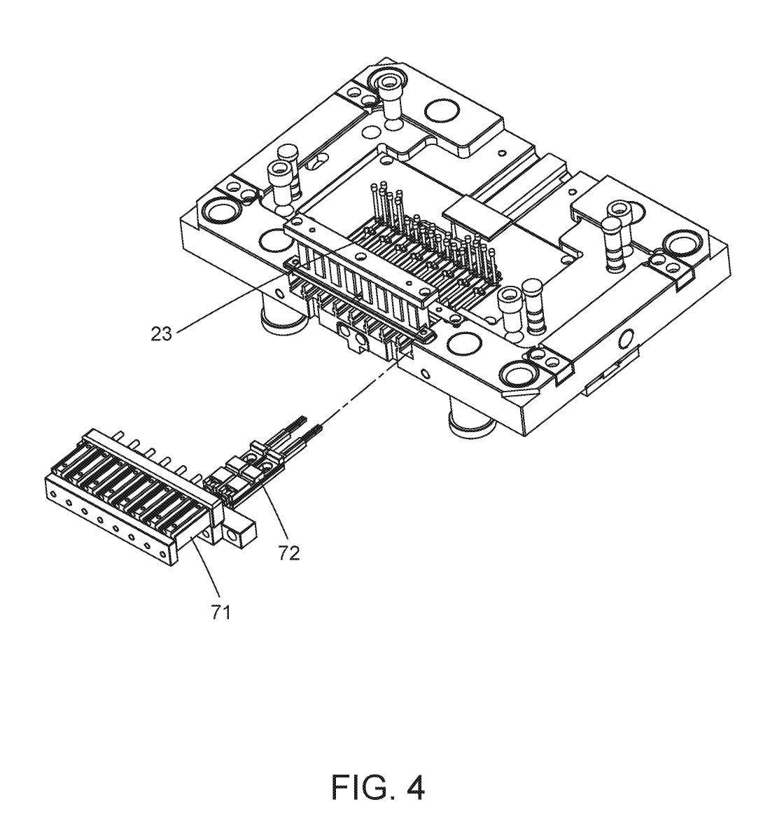

FIG. 5 is a system block diagram of the injection molding terminal pulling machine according to the present invention.

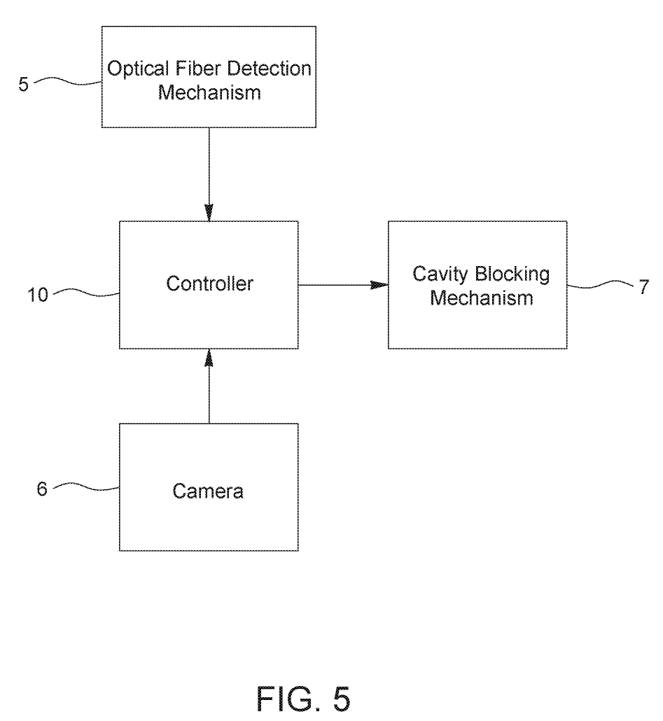

### DETAILED DESCRIPTION OF THE INVENTION

In order to provide a detailed explanation of a technical content, structural features, achieved objectives and effects of the present invention, a following embodiment is provided with accompanying diagrams for a detailed illustration.

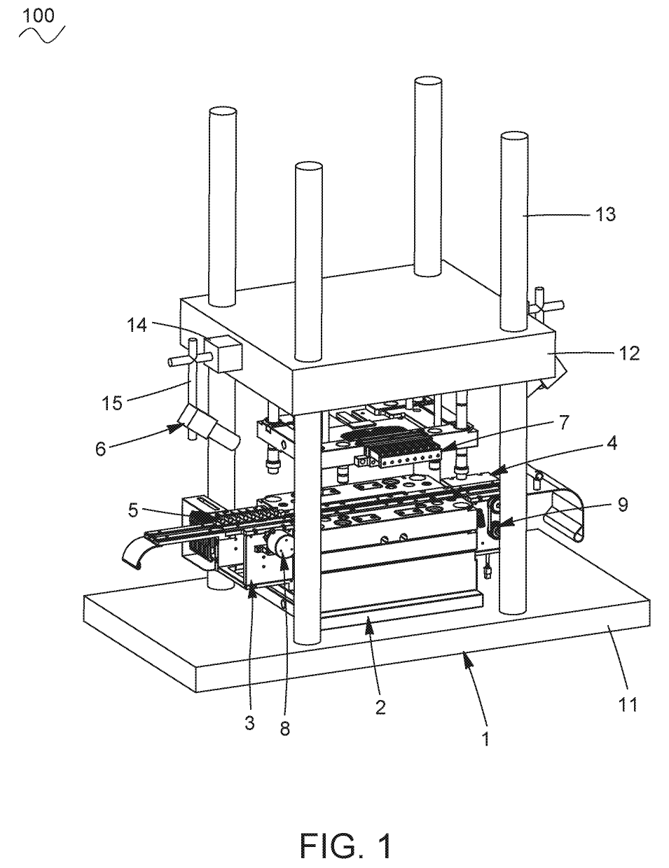

Referring to FIGS. 1 - 5, an injection molding terminal pulling machine 100 in accordance with a preferred embodiment of the present invention is shown. The injection molding terminal pulling machine 100 is used to drive a terminal material strip 200. The injection molding terminal pulling machine 100 includes a base 1, a mold 2, a feeding end 3, a discharging end 4, an optical fiber detection mechanism 5, a plurality of cameras 6, a cavity blocking mechanism 7, a damper 8 and a motor 9. In the preferred embodiment, the injection molding terminal pulling machine 100 includes two cameras 6.

The mold 2 is installed inside the base 1. The feeding end 3 is arranged at one side of the mold 2, and the discharging end 4 is arranged at the other side of the mold 2. The feeding end 3 and discharging end 4 are arranged at a left side and a right side of the mold 2. The feeding end 3 is equipped with the optical fiber detection mechanism 5 and the damper 8. The discharging end 4 is equipped with the motor 9. The optical fiber detection mechanism 5 is located to a top of the feeding end 3. The plurality of the cameras 6 are installed to a left side and a right side of the base 1. The plurality of the cameras 6 are fixed to the base 1. The two cameras 6 are installed to the left side and the right side of the base 1. The two cameras 6 are corresponding to the mold 2. The cavity blocking mechanism 7 is arranged at a front end of an upper portion of the mold 2, and the cavity blocking mechanism 7 is connected to the mold 2.

The cavity blocking mechanism 7 is used to prevent plastic from flowing into specific cavities 23 in the mold 2, product quality is ensured. And the damper 8 is placed at a front end of the feeding end 3. The damper 8 is driven to counter pull the terminal material strip 200 for preventing deformations of a plurality of locating holes (not shown) of the terminal material strip 200, so a terminal loss is reduced, the damper 8 is simple in structure, and the damper 8 has a lower cost. The motor 9 is arranged at a front of the discharging end 4. The motor 9 prevents the deformations of the locating holes (not shown) of the terminal material strip 200 to reduce a terminal loss. The motor 9 has a high precision and a lower cost.

In this preferred embodiment, the damper 8 is a magnetic damper, and the motor 9 is a servo motor. In another feasible embodiment, the motor 9 is a closed-loop stepper motor.

The base 1 has a bottom board 11, a top board 12, a plurality of positioning columns 13, a plurality of protrusions 14 and a plurality of supporting brackets 15. Upper ends and lower ends of the plurality of the positioning columns 13 are connected to the top board 12 and the bottom board 11, respectively. The mold 2 is arranged among the bottom board 11, the top board 12 and the plurality of the positioning columns 13. A left side and a right side of the top board 12 extend outward to form the plurality of protrusions 14.

Specifically, a left side surface and a right side surface of the top board 12 protrude outward to form two protrusions 14. Outer surfaces of the plurality of the protrusions 14 protrude outward, extend vertically and then extend outward to form the plurality of the supporting brackets 15. Two middles of two outer surfaces of the two protrusions 14 protrude outward, extend vertically and then extend outward to form two supporting brackets 15. The plurality of cameras 6 are fixed at bottom ends of the plurality of the supporting brackets 15. In this preferred embodiment, the two cameras 6 are fixed at the bottom ends of the two supporting brackets 15. Each supporting bracket 15 is formed as a cross shape. In a concrete implementation, each supporting bracket 15 is without being limited to be a such design.

The mold 2 has an upper mold 21, a lower mold 22 and a plurality of the cavities 23. The upper mold 21 and lower mold 22 are arranged vertically. The lower mold 22 is positioned below the upper mold 21. The upper mold 21 and the lower mold 22 are separable. The lower mold 22 carries the terminal material strip 200. The plurality of the cameras 6 capture images of the terminal material strip 200 on the lower mold 22 to generate a monitoring signal.

The cavity blocking mechanism 7 is arranged at a front end of the upper mold 21, and the cavity blocking mechanism 7 is connected to the upper mold 21. The plurality of the cameras 6 are corresponding to an upper surface of the lower mold 22. Specifically, the two cameras 6 are corresponding to the upper surface of the lower mold 22. The upper mold 21 has the plurality of the cavities 23 formed in the upper mold 21. Corresponding areas of the cavity blocking mechanism 7 are aligned with the plurality of the cavities 23.

The cavity blocking mechanism 7 has a cylinder 71 and a plurality of sliders 72. The plurality of the sliders 72 are arranged at a rear end of the cylinder 71. The cylinder 71 is corresponding to the plurality of the cavities 23 of the mold 2. The plurality of the sliders 72 are aligned with the plurality of the cavities 23 of the mold 2, and the plurality of the sliders 72 are inserted into the plurality of the cavities 23 of the mold 2.

The injection molding terminal pulling machine 100 judges whether the terminal material strip 200 has a shortage by the optical fiber detection mechanism 5, and the optical fiber detection mechanism 5 stores a judgment result as a position signal. The optical fiber detection mechanism 5 detects the terminal material strip 200 to generate the position signal. After the terminal material strip 200 enters the mold 2, the plurality of the cameras 6 capture the images, and then the plurality of the cameras 6 output the monitoring signal. The injection molding terminal pulling machine 100 has a controller 10. The controller 10 compares the monitoring signal with the position signal to control an operation of the cavity blocking mechanism 7 and an operation of the injection molding terminal pulling machine 100.

In this preferred embodiment, if the optical fiber detection mechanism 5 detects that the shortage is in the terminal material strip 200, and the plurality of the cameras 6 capture abnormally, the sliders 72 of the cavity blocking mechanism 7 automatically block the corresponding cavities 23 of the mold 2.

In this preferred embodiment, if the optical fiber detection mechanism 5 detects that the shortage is in the terminal material strip 200, and the plurality of cameras 6 capture the normal images, the sliders 72 of the cavity blocking mechanism 7 automatically block the corresponding cavities 23 of the mold 2.

In this preferred embodiment, if the optical fiber detection mechanism 5 detects that the terminal material strip 200 is normal, but the plurality of the cameras 6 capture the abnormal images, the terminal material strip 200 is judged to be skewed, warped, deformed or positioned incorrectly, etc. The injection molding terminal pulling machine 100 will give an alarm and stop. The injection molding terminal pulling machine 100 requires a manual confirmation before starting.

In this preferred embodiment, if the optical fiber detection mechanism 5 detects that the terminal material strip 200 is normal, and the plurality of the cameras 6 capture the normal images, the injection molding terminal pulling machine 100 operates normally. Thus, the injection molding terminal pulling machine 100 has advantages of automatically performing mold closing productions needless of a personal confirmation and improving a production efficiency.

As described above, the injection molding terminal pulling machine 100 judges whether the terminal material strip 200 has the shortage by the optical fiber detection mechanism 5, and the judgment result is stored as the position signal. After the terminal material strip 200 enters the mold 2, the plurality of the cameras 6 capture the images and then output the monitoring signal. Furthermore, the controller 10 of the injection molding terminal pulling machine 100 compares the monitoring signal with the position signal to control the operation of the cavity blocking mechanism 7 and the operation of the injection molding terminal pulling machine 100. As a result, the injection molding terminal pulling machine 100 automatically performs the mold closing production needless of the personnel confirmation to improve the production efficiency.

What is claimed is:

1. An injection molding terminal pulling machine, comprising:
a base having a bottom board, a top board, a plurality of positioning columns, a plurality of protrusions and a plurality of supporting brackets, upper ends and lower ends of the plurality of the positioning columns being connected to the top board and the bottom board, respectively, a left side and a right side of the top board extending outward to form the plurality of the protrusions, outer surfaces of the plurality of the protrusions protruding outward, extending vertically and then extending outward to form the plurality of the supporting brackets;
a mold arranged among the bottom board, the top board and the plurality of the positioning columns, the mold having an upper mold and a lower mold, the lower mold being positioned below the upper mold;
a plurality of cameras fixed at bottom ends of the plurality of the supporting brackets, the plurality of the cameras being corresponding to an upper surface of the lower mold;
a cavity blocking mechanism arranged at a front end of the upper mold, and the cavity blocking mechanism being connected to the upper mold;
a feeding end arranged at one side of the mold, the feeding end being equipped with an optical fiber detection mechanism and a damper, the optical fiber detection mechanism being located to a top of the feeding end, and the damper being placed at a front end of the feeding end; and
a discharging end arranged at the other side of the mold, the discharging end being equipped with a motor.

2. The injection molding terminal pulling machine as claimed in claim 1 wherein the upper mold has a plurality of cavities, the cavity blocking mechanism has a cylinder and a plurality of sliders, the plurality of the sliders are arranged at a rear end of the cylinder, the cylinder is corresponding to the plurality of the cavities, and the plurality of the sliders are inserted into the plurality of the cavities.

3. The injection molding terminal pulling machine as claimed in claim 1 wherein the damper is a magnetic damper.

4. The injection molding terminal pulling machine as claimed in claim 1 wherein the motor is a servo motor.

5. The injection molding terminal pulling machine as claimed in claim 1 wherein the motor is a closed-loop stepper motor.

6. The injection molding terminal pulling machine as claimed in claim 1 wherein each supporting bracket is formed as a cross shape.

7. The injection molding terminal pulling machine as claimed in claim 1 wherein the motor is arranged at a front of the discharging end.

8. The injection molding terminal pulling machine as claimed in claim 1 wherein the mold is installed inside the base.

9. The injection molding terminal pulling machine as claimed in claim 1 wherein the damper is driven to counter pull a terminal material strip.

10. The injection molding terminal pulling machine as claimed in claim 9 wherein the injection molding terminal pulling machine judges whether the terminal material strip has a shortage by the optical fiber detection mechanism, and the optical fiber detection mechanism stores a judgment result as a position signal, after the terminal material strip enters the mold, the plurality of the cameras capture images, and then the plurality of the cameras output a monitoring signal, the injection molding terminal pulling machine has a controller, the controller compares the monitoring signal with the position signal to control an operation of the cavity blocking mechanism and an operation of the injection molding terminal pulling machine.

11. An injection molding terminal pulling machine used to drive a terminal material strip, the injection molding terminal pulling machine comprising:
a base;
a mold installed inside the base, the mold having an upper mold and a lower mold, the lower mold carrying the terminal material strip, the upper mold having a plurality of cavities formed in the upper mold;
a feeding end arranged at one side of the mold;
a discharging end arranged at the other side of the mold;
a plurality of cameras fixed to the base, the plurality of the cameras capturing images of the terminal material strip on the lower mold to generate a monitoring signal;
a cavity blocking mechanism connected to the upper mold, the cavity blocking mechanism having a cylinder, and a plurality of sliders arranged at a rear end of the cylinder, the plurality of the sliders being aligned with the plurality of the cavities, and the plurality of the sliders being inserted into the plurality of the cavities;
an optical fiber detection mechanism located to a top of the feeding end, the optical fiber detection mechanism detecting the terminal material strip to generate a position signal;
a damper placed at a front end of the feeding end;
a motor arranged at a front of the discharging end; and
a controller comparing the monitoring signal with the position signal to control the cavity blocking mechanism.

12. An injection molding terminal pulling machine used to drive a terminal material strip, the injection molding terminal pulling machine comprising:
a base;
a mold installed inside the base, the mold having an upper mold and a lower mold, the lower mold carrying the terminal material strip, the upper mold having a plurality of cavities formed in the upper mold;
a feeding end arranged at one side of the mold;
a discharging end arranged at the other side of the mold;
a plurality of cameras fixed to the base, the plurality of the cameras capturing images of the terminal material strip on the lower mold to generate a monitoring signal;
a cavity blocking mechanism connected to the upper mold, corresponding areas of the cavity blocking mechanism being aligned with the plurality of the cavities;
an optical fiber detection mechanism located to a top of the feeding end, the optical fiber detection mechanism detecting the terminal material strip to generate a position signal;
a damper placed at a front end of the feeding end;
a motor arranged at a front of the discharging end; and
a controller comparing the monitoring signal with the position signal to control the cavity blocking mechanism.
